(19) United States
(12) Patent Application Publication
(10) Pub. No.: US 2021/0221474 A1
(43) Pub. Date: Jul. 22, 2021

(54) BIMINI TOP ASSEMBLY

(71) Applicant: Lippert Components, Inc., Elkhart, IN (US)

(72) Inventors: Mark Russell KINDER, Clarks Hill, IN (US); Robert L. TIEDGE, Granger, IN (US)

(21) Appl. No.: 17/153,580

(22) Filed: Jan. 20, 2021

Related U.S. Application Data
(60) Provisional application No. 62/964,273, filed on Jan. 22, 2020.

(51) Int. Cl. B63B 17/02; E05F 15/51

(52) U.S. Cl. CPC B63B 17/02; E05F 15/60; E05F 15/51

(57) ABSTRACT

A pneumatic system utilizes a pneumatic cylinder to deploy and retract a bimini top. The pneumatic system also provides pressurized air to additional peripheral devices. A bimini top assembly includes links to deploy and retract a bimini top with an actuator.

### CROSS-REFERENCES TO RELATED APPLICATIONS

This application claims the benefit of U.S. Provisional Patent Application No. 62/964,273, filed Jan. 22, 2020, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a bimini and bimini top assembly and, more particularly, to a pneumatic system for driving a bimini top assembly along with peripheral devices and a bimini top assembly construction.

A bimini top is traditionally an open-front cover assembly including a top made of canvas or other suitable material for the cockpit of a vehicle such as a boat. It is desirable to enable users to selectively deploy and retract the bimini, which can be done manually or automatically via an actuator or the like.

Because existing bimini assemblies typically include at least a forward bimini arm and an aft bimini arm, automated deployment and retraction can be complicated, requiring multiple actuators and mechanisms to position the bimini arms appropriately.

Some existing actuated biminis utilize a hydraulic cylinder/actuator to position the bimini arms. Hydraulic actuators, however, are not easily adjustable in terms of speed or force. Additionally, hydraulic actuators render the bimini top assemblies more susceptible to damage in the event of impact with an overhead obstacle. Still further, the use of fluids in hydraulic systems raises the potential for leaking hydraulic fluid into the water.

### SUMMARY

A pneumatic system is advantageous for powering multiple features of a boat, including a bimini top assembly. A pump in the form of an air compressor powered by a motor selectively supplies air to the different cylinders or boat features by tubing that could be routed underneath the deck or carpeting of the boat. A pneumatic cylinder is more forgiving in a scenario where a deployed bimini may come in contact with a hard structure such as an overhead bridge. In such event, the air in the cylinder is compressible to allow the bimini arms to push down and return in place instead of breaking after impact. The pneumatic system also enables powering of many functions with one source, is easily expandable, and speed and force components are readily adjustable. Moreover, the use of pneumatic cylinders avoids the potential leak of hydraulic fluids into the water.

A bimini top assembly includes an actuator pivotally attached in a housing at a fixed end, and a driven bimini arm is pivotally connected to an extendable end of the actuator. The actuator may be a pneumatic cylinder, a hydraulic cylinder or an electric actuator. A follower bimini arm is also pivotally connected to the housing, but near the rod end of the cylinder. Both bimini arms are also pivotally connected to a connecting flange or link bar. As the rod extends from the cylinder, it drives the driven bimini arm to a deployed position, which causes the connecting flange to pull the follower bimini arm into the deployed position. The connecting flange could be omitted and the canopy may be used to keep the bimini arms in tension and pull the follower bimini arm into place.

In some embodiments, the bimini arms are forked rods that allow the cylinder rod to pass through the center for actuating the bimini. The forked rods would then connect to a tubular rod to elongate the bimini arms and connect to a canopy. There thus may be two arms and a connecting flange on each side of the housing. In other embodiments, there could be two arms and a connecting flange pivotally connected to one side of the housing and cylinder rod.

In an exemplary embodiment, a bimini top assembly includes a housing, and an actuator disposed in the housing and having a fixed end and an extendable end. The fixed end is pivotally secured to the housing. A bimini arm assembly supports a bimini top and is displaceable by the actuator between a retracted position and a deployed position. The bimini arm assembly includes a driven bimini arm pivotally coupled to the housing, where the extendable end of the actuator is pivotally coupled to the driven bimini arm, a follower bimini arm pivotally coupled to the housing, and a link extending between the driven bimini arm and the follower bimini arm.

The actuator may include a pneumatic cylinder, and the fixed end may include a cylinder end and the extendable end may include a rod end. The actuator may include one of a pneumatic cylinder, a hydraulic cylinder, and an electric actuator.

The link may include a link bar pivotally connected between the driven bimini arm and the follower bimini arm. In this context, the driven bimini arm may be connected to the housing at a distal end of the driven bimini arm, the extendable end of the actuator may be connected to the driven bimini arm at a point spaced from the driven bimini arm distal end, and the link bar may be connected to the driven bimini arm between the point and the driven bimini arm distal end. The follower bimini arm may be connected to the housing at a distal end thereof, and the link bar may be connected to the follower bimini arm at a point spaced from the follower bimini arm distal end.

The bimini arm assembly may include the bimini top connected between the driven bimini arm and the follower bimini arm. The driven bimini arm and the follower bimini arm may include forked rods with fork ends connected to the housing, where the actuator may be positioned between the fork ends. The housing, the actuator and the bimini arm assembly may define a bimini top unit, where the bimini top assembly may include two bimini top units for displacing respective opposite sides of the driven bimini arm and the follower bimini arm.

In another exemplary embodiment, a bimini top assembly including a selectively deployable bimini top for providing a retractable canopy over a structure includes a first housing on a port side of the structure, a second housing on a starboard side of the structure, and an actuator disposed in one of the first and second housings and having a fixed end and an extendable end. The fixed end is pivotally secured to the one of the first and second housings. A bimini arm assembly supports the bimini top over the structure and is displaceable by the actuator between a retracted position and a deployed position. The bimini arm assembly includes a driven bimini arm pivotally coupled to the first and second housings, where the extendable end of the actuator is pivotally coupled to the driven bimini arm, a follower bimini arm pivotally coupled to the first and second housings, and a link extending between the driven bimini arm and the follower bimini arm.

### BRIEF DESCRIPTION OF THE DRAWINGS

These and other aspects and advantages will be described in detail with reference to the accompanying drawings, in which:

FIG. 1 is a schematic drawing of an exemplary pneumatic system;

FIG. 2 shows the bimini top assembly in a retracted position;

FIG. 3 shows the bimini top assembly in an intermediate position;

FIG. 4 shows the bimini top assembly in a deployed position; and

FIG. 5 shows the bimini top assembly deployed on a boat.

### DETAILED DESCRIPTION

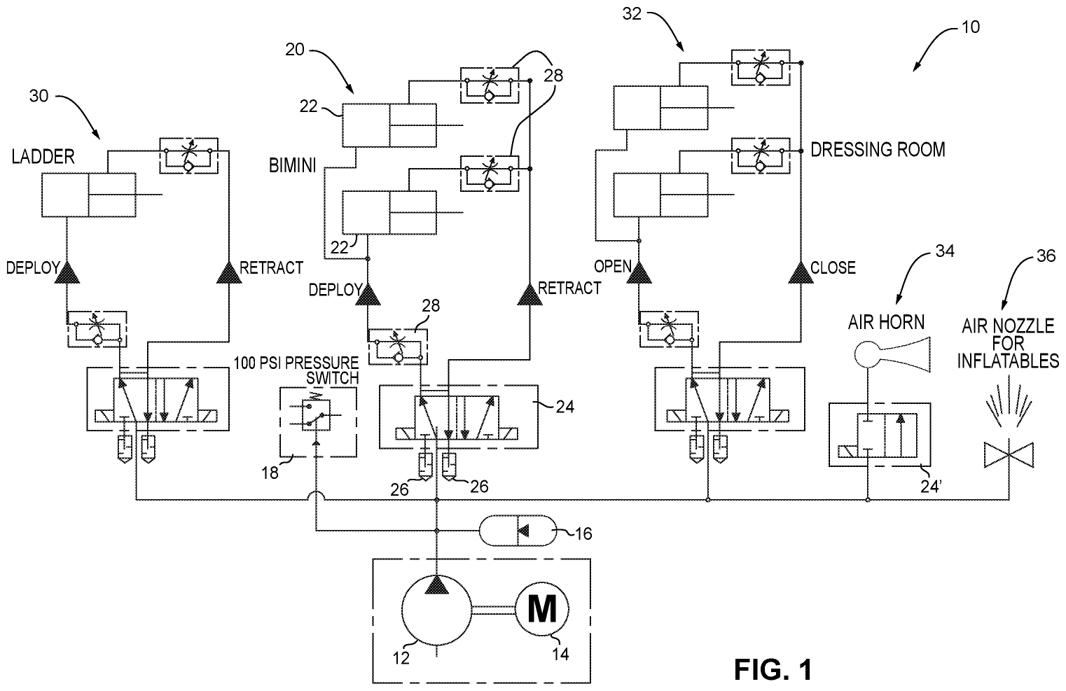

FIG. 1 is a schematic diagram of an exemplary pneumatic system for driving multiple components. In some embodiments, at least one of the components is a bimini top assembly that is deployed and retracted via a pneumatic cylinder. Exemplary peripheral components/devices associated with the pneumatic system shown in FIG. 1 include a ladder, a marine dressing room, an air horn, and an air nozzle for inflatables.

The pneumatic system 10 includes a pump 12 driven by a motor 14. An accumulator 16 is in fluid communication with the pump 12, and a pressure switch 18 is in fluid communication with the accumulator 16 and the pump 12. The accumulator 16 serves to maintain system pressure, and the pressure switch 18 is configured to activate the pump 12 when the pressure in the accumulator 16 is below a predetermined value. The pressure switch 18 similarly deactivates the pump 12 when the pressure in the accumulator 16 is at or above the predetermined value. In the exemplary application shown in FIG. 1, the pressure switch 18 is a 100 psi pressure switch, and as such the predetermined value in the exemplary application is 100 psi. This pressure of course could be varied based on intended applications.

A bimini circuit 20 includes one or two pneumatic cylinders 22 in fluid communication with the pump 12 and coupled with an extendable and retractable bimini top (exemplary bimini top assembly discussed in more detail below).

A flow box switch 24 is positioned between the pump 12 and the bimini circuit 20. The flow box switch 24 is selectively displaceable between an extend position driving pressurized air to the pneumatic cylinders 22 to extend the bimini top and a retract position driving pressurized air to the pneumatic cylinders 22 to retract the bimini top. The exemplary flow box switch 24 shown in FIG. 1 is a two-position, four-way, five-port double solenoid switch. Silencers 26 may be cooperable with the flow box switch 24 to reduce noise associated with activation of the pneumatic cylinders.

The bimini circuit 20 also includes one or more adjustable flow control valves 28 for controlling the speed of any function (e.g., bimini top deployment) and the force at which the function is activated. The adjustable flow control valves 28 may include a bypass on the return side as shown.

The other peripheral devices include corresponding circuits in fluid communication with the pump 12 in parallel with the bimini circuit 20. The flow box switches 24 for the peripheral devices are generally displaceable between an activate position and a deactivate position, depending on the functionality of the circuit. Each of the peripheral device circuits includes a pneumatic output for driving the peripheral device. For example, a ladder circuit 30 may include the pneumatic cylinder for extending and retracting a ladder; a dressing room circuit 32 may include one or more pneumatic cylinders for inflating/deflating an inflatable dressing room; an air horn circuit 34 may use the pressurized air to activate the air horn; and an air nozzle 36 may be provided for inflatable products. The flow box switch for the air horn 24′ is shown as a two-position, two-way, two-port single solenoid switch. The adjustable flow control valve 28 is not required for the air horn circuit 34. The air nozzle 36 simply serves as a source of pressurized air for inflating floats, inner tubes, etc.

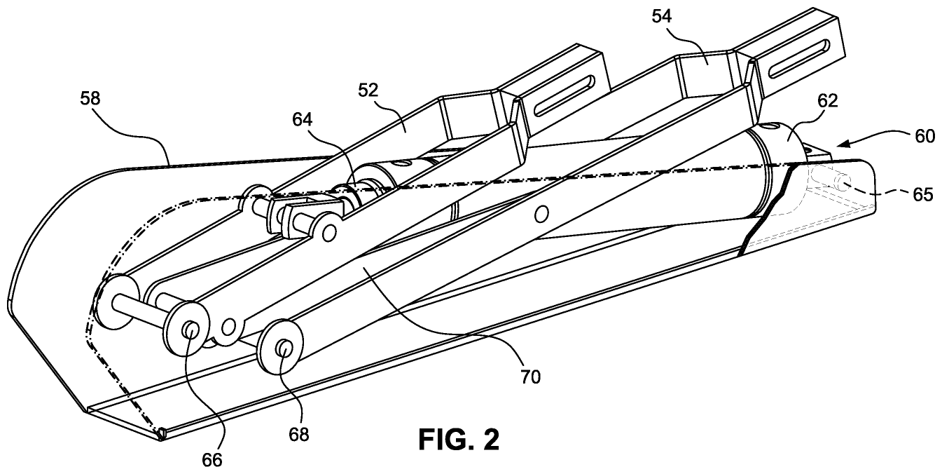

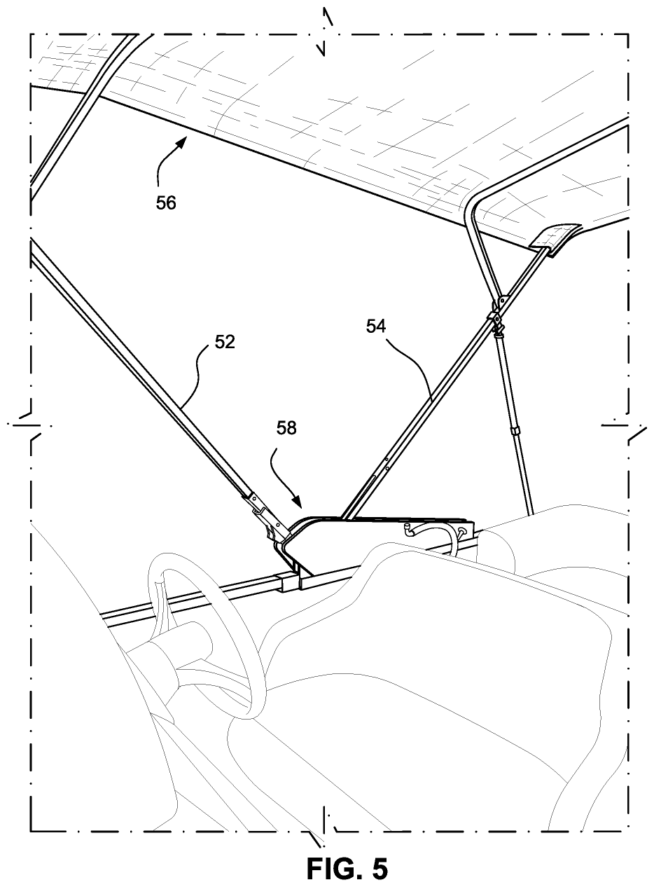

FIGS. 2-5 show an exemplary bimini top assembly including a selectively deployable bimini top for providing a retractable canopy over a structure such as the cockpit or passenger area of a boat. FIG. 5 shows an exemplary bimini top deployed over a boat deck. Among other aspects, the bimini top assembly generally includes a forward bimini arm 52 and an aft bimini arm 54. The bimini arms 52, 54 support a bimini top 56 made of canvas or other suitable material. The bimini top assembly/operating components include first and second housings 58 secured on port and starboard sides of the structure. In some embodiments, the housings 58 encompass identical structure including an actuator (described in more detail below) and operating connections to deploy and retract the bimini. It is contemplated that the internal components may alternatively be included in only one of the housings 58, depending on viability, the size of the bimini top, the weight of the bimini top, among other factors.

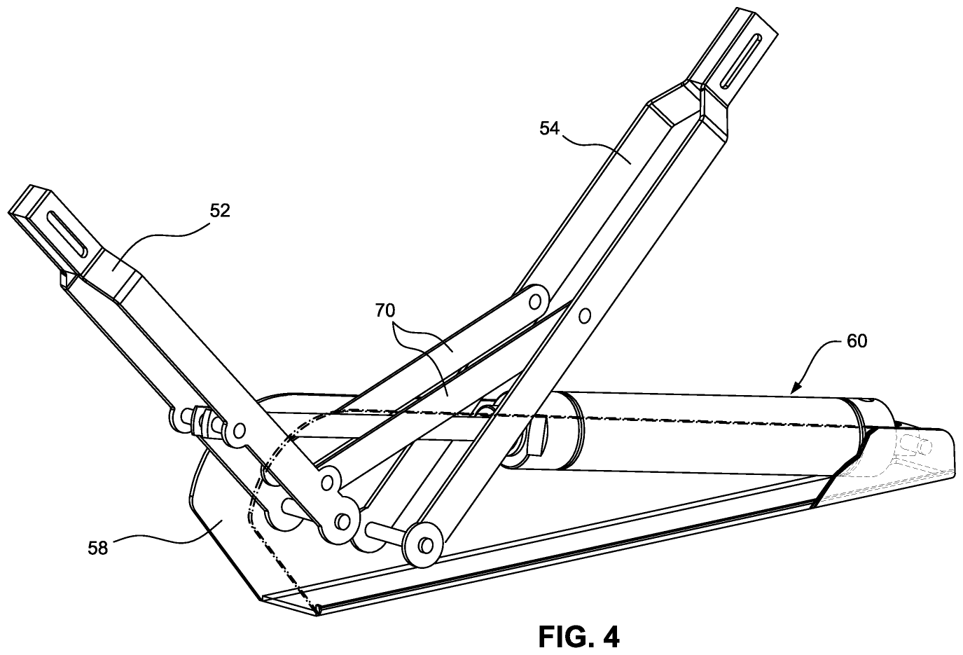

With reference to FIGS. 2-4, the bimini top assembly includes the housing 58 and an actuator 60 disposed in the housing 58 and having a fixed end 62 and an extendable end 64. The actuator 60 is pivotally attached to the housing at a first pivot point 65. A bimini arm assembly supports the bimini top and is displaceable by the actuator 60 between the retracted position (FIG. 2) and the deployed position (FIG. 4).

The bimini arm assembly includes a driven bimini arm, which in an exemplary embodiment corresponds to the forward bimini arm 52, and a follower bimini arm which in the exemplary embodiment corresponds to the aft bimini arm 54. In some applications, the arms 52, 54 could be reversed. The driven bimini arm 52 and the follower bimini arm 54 may include forked rods as shown with forked ends connected to the housing 58. In this construction, the actuator 60 is positioned between the forked ends.

The driven bimini arm 52 is pivotally coupled to the housing 58 at a distal end thereof at a second pivot point 66. The follower bimini arm 54 is pivotally coupled to the housing 58 at a third pivot point 68. A link bar 70 extends between the driven bimini arm 52 and the follower bimini arm 54.

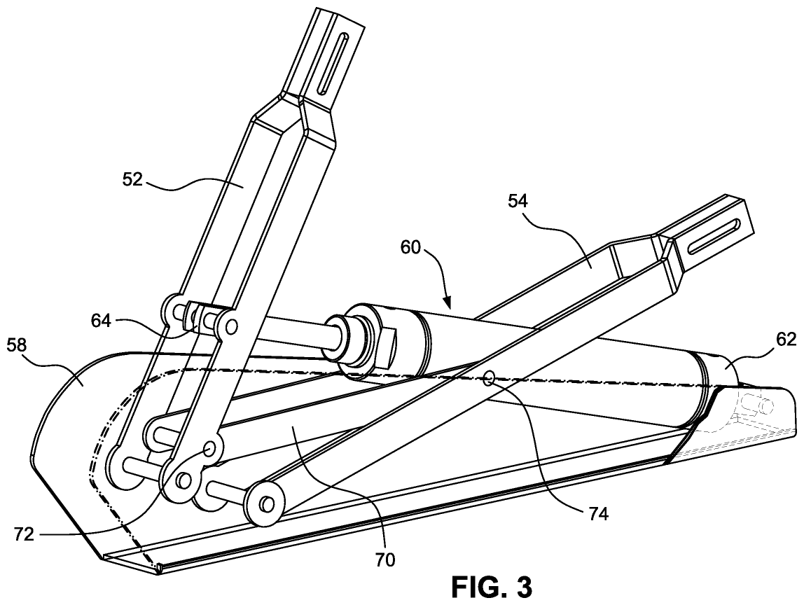

As best seen in FIGS. 3 and 4, the driven bimini arm 52 is connected to the housing 58 at a distal end of the driven bimini arm 52. The extendable end 64 of the actuator 60 is connected to the driven bimini arm 52 at a connection point spaced from the driven bimini arm distal end. The link bar 70 is connected to the driven bimini arm 52 at a fourth pivot point 72 between the connection point for the extendable end 64 of the actuator 60 and the driven bimini arm distal end. The follower bimini arm 54 is connected to the housing 58 at a distal end of the follower bimini arm 54. The link bar 70 is connected to the follower bimini arm 54 at a fifth pivot point 74 spaced from the follower bimini arm distal end.

In some embodiments, the actuator 60 may be a pneumatic cylinder (such as the pneumatic cylinder 22 described in connection with the pneumatic system shown in FIG. 1), a hydraulic cylinder or an electric actuator. With a hydraulic or pneumatic cylinder, the fixed end 62 may be a cylinder end, and the extendable end 64 may be a rod end.

As an alternative to the link bar 70, the link between the driven bimini arm 52 and the follower bimini arm 54 may instead be the bimini top itself connected between the respective arms 52, 54.

In use, from the retracted position shown in FIG. 2, as the actuator 60 is extended, the driven bimini arm 52 is pivoted by the actuator 60 toward the position shown in FIG. 3. As the driven bimini arm 52 is displaced (counterclockwise in the drawings), the driven bimini arm 52 displaces the link bars 70, which in turn pivot the follower bimini arm 54. As the actuator 60 is fully extended to the position shown in FIG. 4, the driven bimini arm 52 and the follower bimini arm 54 are secured in a fully deployed position. The assembly can be retracted by retracting the extendable end 64 of the actuator 60 to the position shown in FIG. 2.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A bimini top assembly comprising:
a housing;
an actuator disposed in the housing and having a fixed end and an extendable end, the fixed end being pivotally secured to the housing; and
a bimini arm assembly supporting a bimini top and being displaceable by the actuator between a retracted position and a deployed position, the bimini arm assembly including:
a driven bimini arm pivotally coupled to the housing, wherein the extendable end of the actuator is pivotally coupled to the driven bimini arm,
a follower bimini arm pivotally coupled to the housing, and
a link extending between the driven bimini arm and the follower bimini arm.

2. A bimini top assembly according to claim 1, wherein the actuator comprises a pneumatic cylinder, and wherein the fixed end comprises a cylinder end and the extendable end comprises a rod end.

3. A bimini top assembly according to claim 1, wherein the actuator comprises one of a pneumatic cylinder, a hydraulic cylinder, and an electric actuator.

4. A bimini top assembly according to claim 1, wherein the link comprises a link bar pivotally connected between the driven bimini arm and the follower bimini arm.

5. A bimini top assembly according to claim 4, wherein the driven bimini arm is connected to the housing at a distal end of the driven bimini arm, wherein the extendable end of the actuator is connected to the driven bimini arm at a point spaced from the driven bimini arm distal end, and wherein the link bar is connected to the driven bimini arm between the point and the driven bimini arm distal end.

6. A bimini top assembly according to claim 5, wherein the follower bimini arm is connected to the housing at a distal end of the follower bimini arm, and wherein the link bar is connected to the follower bimini arm at a point spaced from the follower bimini arm distal end.

7. A bimini top assembly according to claim 1, wherein the link comprises the bimini top connected between the driven bimini arm and the follower bimini arm.

8. A bimini top assembly according to claim 1, wherein the driven bimini arm and the follower bimini arm comprise forked rods with fork ends connected to the housing, and wherein the actuator is positioned between the fork ends.

9. A bimini top assembly according to claim 1, wherein the housing, the actuator and the bimini arm assembly define a bimini top unit, and wherein the bimini top assembly comprises two bimini top units for displacing respective opposite sides of the driven bimini arm and the follower bimini arm.

10. A bimini top assembly including a selectively deployable bimini top for providing a retractable canopy over a structure, the bimini top assembly comprising:
a first housing on a port side of the structure;
a second housing on a starboard side of the structure;
an actuator disposed in one of the first and second housings and having a fixed end and an extendable end, the fixed end being pivotally secured to the one of the first and second housings; and
a bimini arm assembly supporting the bimini top over the structure and being displaceable by the actuator between a retracted position and a deployed position, the bimini arm assembly including:
a driven bimini arm pivotally coupled to the first and second housings, wherein the extendable end of the actuator is pivotally coupled to the driven bimini arm,
a follower bimini arm pivotally coupled to the first and second housings, and
a link extending between the driven bimini arm and the follower bimini arm.

11. A bimini top assembly according to claim 10, comprising two actuators, one each respectively disposed in the first and second housings.
